(19) United States
(12) Patent Application Publication
(10) Pub. No.: US 2006/0244965 A1
(43) Pub. Date: Nov. 2, 2006

(54) Light scattering type particle detector

(75) Inventor: Kazuo Ichijo, Tokyo (JP)

Correspondence Address: CARRIER BLACKMAN AND ASSOCIATES, 24101 NOVI ROAD, SUITE 100, NOVI, MI, 48375, US

(73) Assignee: Rion Co., Ltd., Tokyo (JP)

(21) Appl. No.: 10/527,488

(22) PCT Filed: Sep. 13, 2002
(86) PCT No.: PCT/JP02/09393

§ 371 Date: Sep. 2, 2005

(51) Int. Cl. G01N 21/00

(52) U.S. Cl. 356/338

(57) ABSTRACT

A light scattering type particle detector includes a light having a low-energy intensity emitted from a light sources which is converted into light having a high-energy intensity so as to detect fine particles. In the light scattering type particle detector, particles contained in fluid are irradiated with light Lb, and scattered light Ls generated by the particles is received so as to detect the presence of the particles. The light Lb is obtained by converting light La having a wavelength of λ emitted from a light-emitting diode into light having a wavelength of λ/2 after being transmitted through a nonlinear optical crystal. The light Lb having a wavelength of λ/2 is allowed to reciprocate between a reflecting film of the nonlinear optical crystal and a reflecting mirror so as to be intensified.

### TECHNICAL FIELD

The present invention relates to a light scattering type particle detector in which fluid to be monitored is introduced into a particle detecting area, particles contained in the fluid are irradiated with light, and scattered light by the particles is received so as to detest presence of the particles.

### BACKGROUND ART

Conventionally, in order to detect fine particles contained in fluid, the fluid is allowed to flow through an area where laser light having a high intensity of energy resonates, so that the particles can be irradiated with such laser light. In this way, fine particles can be detected. As an example, there is known a light scattering type particle detector such as shown in FIG. 6, which employs a solid-state laser pumped by a semiconductor laser (for example, see U.S. Pat. No. 5,642,193 and U.S. Pat. No. 5,903,347).

In the conventional light scattering type particle detector, pumping laser light Le emitted from a semiconductor laser 100 is condensed with a condenser lens system 101 toward a solid-state laser medium 102, and thereby laser light La is emitted form the solid-state laser medium 102. After the laser light La is transmitted through a nonlinear optical crystal 103 so as to reduce the wavelength thereof, the laser light La is directed to fluid. The particle detector further comprises a reflecting mirror 104, a flow path 105 which is defined by fluid flowing in direction A, a laser driving circuit 106 having a temperature controlling circuit for controlling the temperature of the semiconductor laser 100, a Peltier device 107, a heat sink 108, a particle detecting area 109, and a light receiving portion 110.

However, in the conventional light scattering type particle detector, it is necessary to control the wavelength λ of the pumping laser light Le emitted from the semiconductor laser 100 to be a wavelength in which the solid-state laser medium 102 can absorb energy most effectively (such as 810 nm).

In order to control the wavelength λ of the pumping laser light Le, the temperature of the semiconductor laser 100 needs to be controlled. For this purpose, the conventional particle detector requires the temperature controlling circuit 106, the Peltier device 107, the heat sink 108 or the like. Consequently, there is a drawback that the elements for controlling the temperature of the semiconductor laser 100 are considerably large-scale.

The present invention was made to solve the above-mentioned drawback, and the object of the present invention is to provide a light scattering type particle detector in which light having a low energy intensity emitted from a light source is converted into light having a high energy intensity so as to detect fine particles.

### DISCLOSURE OF THE INVENTION

For solving the above-mentioned drawback according to an aspect of the present invention, there is provided a light scattering type particle detector in which particles contained in fluid are irradiated with light, and light scattered by the particles is received so as to detect the particles, wherein the light is obtained by converting the wavelength of light emitted from a light source with a nonlinear optical crystal.

According to another aspect of the present invention, in the above light scattering type particle detector, the light is reciprocated between a reflecting film of the nonlinear optical crystal and a mirror, or between a mirror and a mirror, which oppose one another with the particle detecting area interposed therebetween.

### BRIEF DESCRIPTION OF THE DRAWINGS

FIG. 1 is a schematic view of a light scattering type particle detector according to the first embodiment of the present invention;

FIG. 2 is a schematic view of a light scattering type particle detector according to the second embodiment of the present invention;

FIG. 3 is a schematic view of a light scattering type particle detector according to the third embodiment of the present invention;

FIG. 4 is a schematic view of a light scattering type particle detector according to the fourth embodiment of the present invention;

FIG. 5 is a schematic view of a light scattering type particle detector according to the fifth embodiment of the present invention; and

FIG. 6 is a schematic view of a conventional light scattering type particle detector.

### BEST MODE FOR CARRYING OUT THE INVENTION

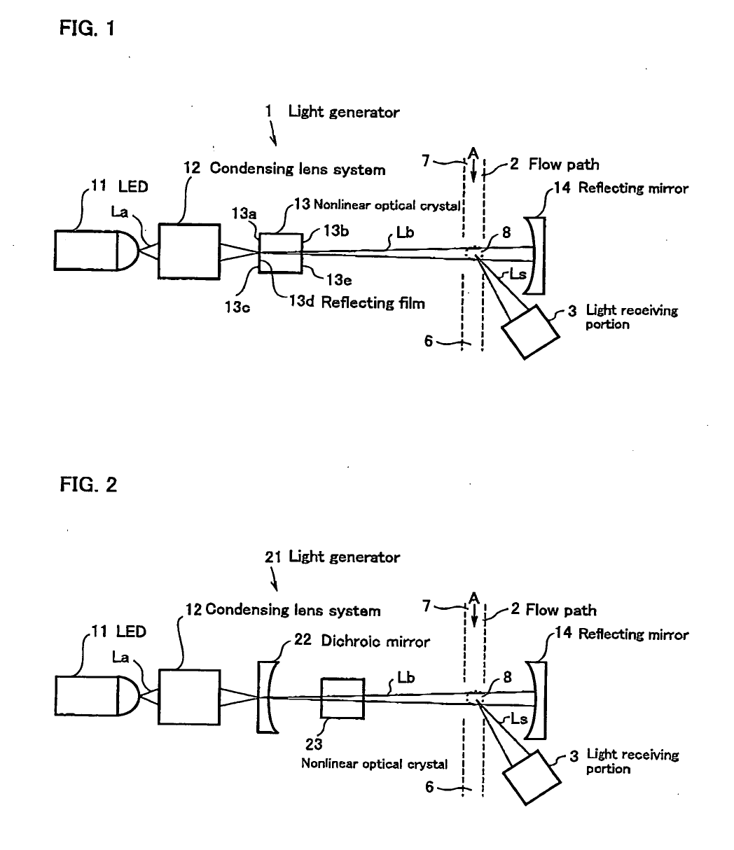

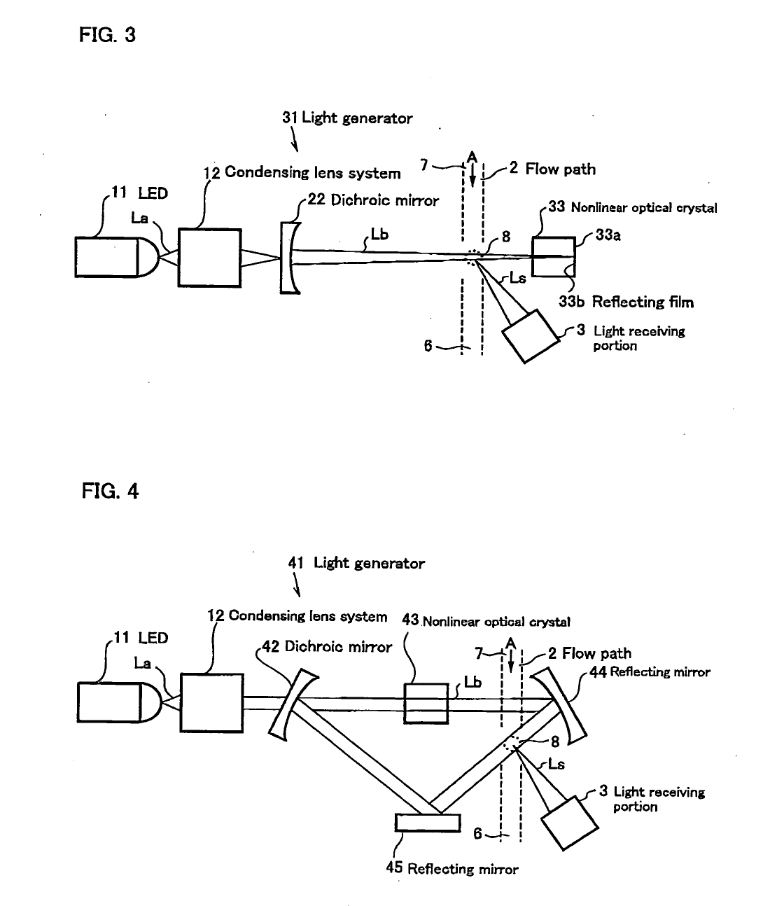

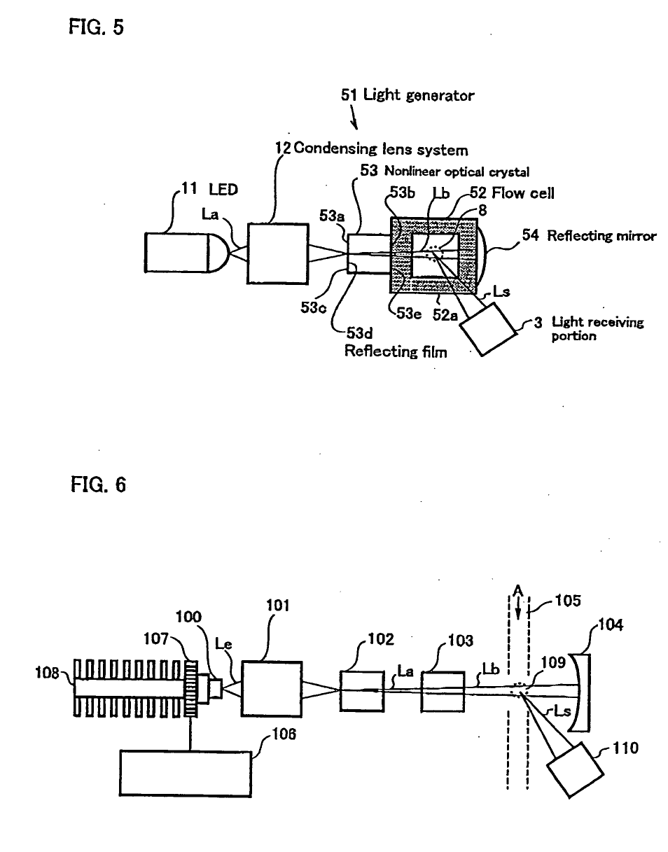

Preferred embodiments of the present invention will now be described with reference to the accompanying drawings. FIG. 1 is a schematic view of a light scattering type particle detector according to the first embodiment of the present invention, FIG. 2 is a schematic view of a light scattering type particle detector according to the second embodiment, FIG. 3 is a schematic view of a light scattering type particle detector according to the third embodiment, FIG. 4 is a schematic view of a light scattering type particle detector according to the fourth embodiment, and FIG. 5 is a schematic view of a light scattering type particle detector.

As shown in FIG. 1, the light scattering type particle detector according to the first embodiment is comprised of a light generator 1 for generating light Lb, a flow path 2 which is defined by fluid to be monitored, and a light receiving portion 3 for receiving scattered light Ls.

The light generator 1 comprises a light-emitting diode (LED) 11 for emitting light La having a wavelength of λ as a light source, a condensing lens system 12 for condensing the light La emitted from the LED 11, a nonlinear optical crystal 13 for emitting a second harmonic (light Lb having a wavelength of λ/2) by receiving the light La having a wavelength of λ condensed with the condensing lens system 12, and a reflecting mirror 14 for reflecting the light Lb having a wavelength of λ/2 emitted from the nonlinear optical crystal 13 to reflect the light Lb back to the nonlinear optical crystal 13. The nonlinear optical crystal 13 and the reflecting mirror 14 which oppose one another with the particle detecting area interposed therebetween.

The nonlinear optical crystal 13 can also emit a fundamental harmonic (light La having a wavelength of λ), a third harmonic (light having a wavelength of λ/3), a fourth harmonic (light having a wavelength of λ/4) and so on as well as a second harmonic (light Lb having a wavelength of λ/2). However, the case of using a second harmonic will be explained hereinafter.

An anti-reflecting film 13c and a reflecting film 13d are provided in an end surface 13a of the nonlinear optical crystal 13 on the side of the condensing lens system 12. The anti-reflecting film 13c transmits the light La emitted from the LED 11. The reflecting films 13d reflects a second harmonic (light Lb having a wavelength of λ/2) emitted from the nonlinear optical crystal 13, and transmits a fundamental harmonic (light La having a wavelength of λ) and harmonics other than a second harmonic (ight Lb having a wavelength of λ/2).

Another anti-reflecting film 13e with respect to the light Lb having a wavelength of λ/2 emitted from the nonlinear optical crystal 13 is provided in the other end surface 13b of the nonlinear optical crystal 13 on the side of the reflecting mirror 14. Since the reflecting mirror 14 reflects all kinds of light, only a second harmonic (light Lb having a wavelength of λ/2) reciprocates between the nonlinear optical crystal 13 and the reflecting mirror 14.

The flow path 2 is defined by fluid to be monitored which flows from an inlet 7 to an outlet 6 in direction A by aspirating with an aspirating pump (not shown in the drawings) connected to the downstream of the outlet 6. The area where the light Lb and the flow path 2 intersect perpendicularly is a particle detecting area 8.

The light receiving portion 3 comprises a receiving lens for receiving scattered light Ls generated in the particle detecting area 8, and a photodiode for photoelectrically converting the scattered light Ls. If particles are contained in the fluid, the light Ls scattered by the particles irradiated with the light Lb in the particle detecting area 8 is received, and an electric signal depending on the intensity of the scattered light Ls is output.

The operation of the above-mentioned light scattering type particle detector according to the first embodiment will be explained hereinafter.

The light La having a wavelength of λ emitted from the LED 11 is condensed with the condensing lens system 12 and introduced to the nonlinear optical crystal 13. The light La having a wavelength of λ is converted into the light Lb having a wavelength of λ/2 when emitted from the nonlinear optical crystal 13.

The light Lb having a wavelength of λ/2 emitted from the nonlinear optical crystal 13 is reflected on the reflecting mirror 14 so as to reflect back to the nonlinear optical crystal 13, and reflected on the reflecting film 13d formed on the end surface 13a of the nonlinear optical crystal 13. In this way, the light Lb having a wavelength of λ/2 is allowed to reciprocate between the reflecting film 13d and the reflecting mirror 14.

Consequently, the light Lb is confined within an area between the reflecting film 13d and the reflecting mirror 14, and thereby higher energy intensity can be obtained compared to the light La emitted from the LED 11.

In addition, since the wavelength λ/2 of the light Lb which forms the particle detecting area 8 is half of the wavelength λ of the light La emitted from the LED 11, the intensity of the scattered light from the light Lb is higher than that from the light La. This is because the intensity of light scattered by particles is inversely proportional to the fourth power of the wavelength λ/2 of the light Lb incident upon the particles.

As shown in FIC 2, the light scattering type particle detector according to the second embodiment is comprised of a light generator 21 for generating light Lb, a flow path 2 which is defined by fluid to be monitored, and a light receiving portion 3 for receiving scattered light Ls.

The light generator 21 comprises a light-emitting diode (LED) 11 for emitting light La having a wavelength of λ as a light source, a condensing lens system 12 for condensing the light a emitted from the LED 11, a dichroic mirror 22 for transmitting the light La condensed with the condensing lens system 12, a nonlinear optical crystal 23 for emitting a second harmonic (light Lb having a wavelength of λ/2) by receiving the light La having a wavelength of λ transmitted through the dichroic mirror 22, and a reflecting mirror 14 for reflecting the light Lb having a wavelength of λ/2 emitted from the nonlinear optical crystal 23 to reflect the light Lb back to the dichroic mirror 22. The nonlinear optical crystal 23 and the reflecting mirror 14 oppose one another with the flow path 2 interposed therebetween.

The nonlinear optical crystal 23 can also emit a fundamental harmonic (light La having a wavelength of λ), a third harmonic (light having a wavelength of λ/3), a fourth harmonic (light having a wavelength of λ/4) and so on as well as a second harmonic (light Lb having a wavelength of λ/2). However, the case of using a second harmonic will be explained hereinafter.

The dichroic mirror 22 transmits a fundamental harmonic (light La having a wavelength of λ) and harmonics other than a second harmonic (light Lb having a wavelength of λ/2), and reflects only a second hamonic (light Lb having a wavelength of λ/2) selectively. Since the reflecting mirror 14 reflects all kinds of light, only a second harmonic (light 1b having a wavelength of λ/2) reciprocates between the dichroic mirror 22 and the reflecting mirror 14.

Explanations are omitted regarding the elements having the same reference shown in FIG. 1 such as the flow path 2, the light receiving portion 3 or the like because they are the same as the first embodiment.

The operation of the above-mentioned light scattering type particle detector according to the second embodiment will be explained hereinafter.

The light La having a wavelength of λ emitted from the LED 11 is condensed with the condensing lens system 12 and transmitted through the dichroic mirror 22. The transmitted light La is incident upon the nonlinear optical crystal 23. The light La having a wavelength of λ is converted into the light Lb having a wavelength of λ/2 when emitted from the nonlinear optical crystal 23.

The light Lb having a wavelength of λ/2 emitted from the nonlinear optical crystal 23 is reflected on the reflecting mirror 14 so as to reflect back to the nonlinear optical crystal 23, transmitted through the nonlinear optical crystal 23, and reflected on the dichroic mirror 22. In this way, the light Lb having a wavelength of λ/2 is allowed to reciprocate between the dichroic mirror 22 and the reflecting mirror 14.

Consequently, the light Lb is confined within an area between the dichroic mirror 22 and the reflecting mirror 14, and thereby higher energy intensity can be obtained compared to the light La emitted from the LED 11.

In addition, since the wavelength of the light Lb which forms the particle detecting area 8 is half of the wavelength of the light La emitted from the IED 11, the intensity of the scattered light from the light Lb is higher than that from the light La. This is because the intensity of light scattered by particles is inversely proportional to the fourth power of the wavelength λ/2 of the light Lb incident upon the particles.

As shown in FIG. 3, the light scattering type particle detector according to the third embodiment is comprised of a light generator 31 for generating light Lb, a flow path 2 which is defined by fluid to be monitored, and a light receiving portion 3 for receiving scattered light Ls.

The light generator 31 comprises a light-emitting diode (LED) 11 for emitting light La having a wavelength of λ as a light source, a condensing lens system 12 for condensing the light La emitted from the LED 11, a dichroic mirror 22 for transmitting the light La condensed with the condensing lens system 12, and a nonlinear optical crystal 33 for emitting a second harmonic (light Lb having a wavelength of λ/2) by receiving the light La having a wavelength of λ transmitted through the dichroic mirror 22.

The nonlinear optical crystal 33 can also emit a fundamental harmonic (light La having a wavelength of λ), a third harmonic (light having a wavelength of λ/3), a fourth harmonic (light having a wavelength of λ/4) and so on as well as a second harmonic (light Lb having a wavelength of λ/2). However, the case of using a second harmonic will be explained hereinafter.

A reflecting film 33b is provided in an end surface 33a of the nonlinear optical crystal 33 on the opposite side of the dichroic mirror 22. The reflecting film 33b reflects a second harmonic (light Lb having a wavelength of λ/2) transmitted through the nonlinear optical crystal 33, and transmits a fundamental harmonic (light La having a wavelength of λ) and harmonics other than a second harmonic (light Lb having a wavelength of λ/2).

Explanations are omitted regarding the elements having the same reference shown in FIG. 1 and FIG. 2 such as the flow path 2, the light receiving portion 3, the dichroic mirror 22 or the like because they are the same as the first embodiment and the second embodiment.

The operation of the above-mentioned light scattering type particle detector according to the third embodiment will be explained hereinafter.

The light La having a wavelength of λ emitted from the LED 11 is condensed with the condensing lens system 12 and transmitted through the dichroic minor 22. The transmitted light La is incident upon the nonlinear optical crystal 33. The light La having a wavelength of λ is converted into the light Lb having a wavelength of λ/2 when transmitted through the nonlinear optical crystal 33.

The light Lb having a wavelength of λ/2 transmitted through the nonlinear optical crystal 33 is reflected on the reflecting film 33b formed on the end surface 33a of the nonlinear optical crystal 33, transmitted through the nonlinear optical crystal 33 again, and reflected on the dichroic mirror 22. In this way, the light Lb having a wavelength of λ/2 is allowed to reciprocate between the dichroic mirror 22 and the reflecting film 33b of the nonlinear optical crystal 33.

Consequently, the light Lb is confined within an area between the dichroic mirror 22 and the reflecting film 33b, and thereby higher energy intensity can be obtained compared to the light La emitted from the LED 11.

In addition, since the wavelength of the light Lb which forms the particle detecting area 8 is half of the wavelength of the light La emitted from the LED 11, the intensity of the scattered light from the light Lb is higher than that from the light La. This is because the intensity of light scattered by particles is inversely proportional to the fourth power of the wavelength λ/2 of the light Lb incident upon the particles.

As shown in FIG. 4, the light scattering type particle detector according to the fourth embodiment is comprised of a light generator 41 for generating light Lb, a flow path 2 which is defined by fluid to be monitored, and a light receiving portion 3 for receiving scattered light Ls.

The light generator 41 comprises a light-emitting diode (LED) 11 for emitting light La having a wavelength of λ as a light source, a condensing lens system 12 for condensing the light La emitted from the LED 11, a dichroic mirror 42 for transmitting the light La condensed with the condensing lens system 12, a nonlinear optical crystal 43 for emitting a second harmonic (light Lb having a wavelength of λ/2) by receiving the light La having a wavelength of λ transmitted through the dichroic mirror 42, and reflecting mirrors 44 and 45 for reflecting the light Lb emitted from the nonlinear optical crystal 43 to reflect the light Lb back to the dichroic mirror 42.

The nonlinear optical crystal 43 can also emit a fundamental harmonic (light La having a wavelength of λ), a third harmonic (light having a wavelength of λ/3), a fourth harmonic (light having a wavelength of λ/4) and so on as well as a second harmonic (light Lb having a wavelength of λ/2). However, the case of using a second harmonic will be explained hereinafter.

The dichroic mirror 42 transmits a fundamental harmonic (light La having a wavelength of λ) and harmonics other than a second harmonic (light Lb having a wavelength of λ/2), and reflects only a second harmonic (light Lb having a wavelength of λ/2) selectively. Since the reflecting mirrors 44 and 45 reflect all kinds of light, only a second harmonic (light Lb having a wavelength of λ/2) reciprocates between the dichroic mirror 42 and the reflecting mirrors 44 and 45.

Explanations are omitted regarding the elements having the same reference shown in FIG. 1 such as the flow path 2, the light receiving portion 3 or the like because they are the same as the first embodiment.

The operation of the above-mentioned light scattering type particle detector according to the fourth embodiment will be explained hereinafter.

The light La having a wavelength of λ emitted from the LED 11 is condensed with the condensing lens system 12 and transmitted through the dichroic mirror 42. The transmitted light La is incident upon the nonlinear optical crystal 43. The light La having a wavelength of λ is converted into the light Lb having a wavelength of λ/2 when emitted from the nonlinear optical crystal 43.

The light Lb having a wavelength of λ/2 transmitted through the nonlinear optical crystal 43 is reflected on the reflecting mirror 44, the reflecting mirror 45, and thereafter reflected on dichroic mirror 42. In this way, the light Lb having a wavelength of λ/2 is allowed to circulate through the dichroic mirror 42, the nonlinear optical crystal 43, the reflecting mirror 44, and the reflecting mirror 45 in this order.

Consequently, the light Lb is confined within an area among the dichroic mirror 42, the reflecting mirrors 44 and 45, and thereby higher energy intensity can be obtained compared to the light La emitted from the LED 11.

In addition, since the wavelength of the light Lb which forms the particle detecting area 8 is half of the wavelength of the light La emitted from the LED 11, the intensity of the scattered light from the light Lb is higher than that from the light La. This is because the intensity of light scattered by particles is inversely proportional to the fourth power of the wavelength λ/2 of the light Lb incident upon the particles.

As shown in FIG. 5, the light scattering type particle detector according to the fifth embodiment is comprised of a light generator 51 for generating light Lb, a flow cell 52 which is defined by fluid to be monitored, and a light receiving portion 3 for receiving scattered light Ls.

The light generator 51 comprises a light-emitting diode (LED) 11 for emitting light La having a wavelength of λ as a light source, a condensing lens system 12 for condensing the light La emitted from the LED 11, a nonlinear optical crystal 53 for emitting a second harmonic (light Lb having a wavelength of λ/2) by receiving the light La having a wavelength of λ condensed with the condensing lens system 12, and a reflecting mirror 54 for reflecting the light Lb having a wavelength of λ/2 emitted from the nonlinear optical crystal 53 to reflect the light Lb back to the nonlinear optical crystal 53. The nonlinear optical crystal 53 and the reflecting mirror 54 oppose one another with the flow cell 52 interposed therebetween.

The nonlinear optical crystal 53 can also emit a fundamental harmonic (light La having a wavelength of λ), a third harmonic (Light having a wavelength of λ/3), a fourth harmonic (light having a wavelength of λ/4) and so on as well as a second harmonic (light Lb having a wavelength of λ/2). However, the case of using a second harmonic will be explained hereinafter.

An anti-reflecting film 53c and a reflecting film 53d are provided in an end surface 53a of the nonlinear optical crystal 53 on the side of the condensing lens system 12. The anti-reflecting film 53c transmits the light La emitted from the LED 11. The reflecting film 53d reflects a second harmonic (light Lb having a wavelength of λ/2) emitted from the nonlinear optical crystal 53, and transmits a fundamental harmonic (light La having a wavelength of λ) and harmonics other than a second harmonic (light Lb having a wavelength of λ/2).

Another anti-reflecting film 53e with respect to the light Lb having a wavelength of λ/2 emitted from the nonlinear optical crystal 53 is provided in the other end surface 53b of the nonlinear optical crystal 53 on the side of the reflecting mirror 54. Since the reflecting mirror 54 reflects all kinds of light, only a second harmonic (light Lb having a wavelength of λ/2) reciprocates between the nonlinear optical crystal 53 and the reflecting mirror 54.

The flow cell 52 is a tubular member having a rectangular cross section Fluid to be monitored flows from an inlet to an outlet in the direction perpendicular to the paper by aspirating with an aspirating pump connected to the downstream of the outlet. The area where the light Lb and the fluid intersect is a particle detecting area 8. The nonlinear optical crystal 53 and the reflecting mirror 54 are bonded to an outer wall 52a of the flow cell 52 in a state where the nonlinear optical crystal 53 and the reflecting mirror 54 are opposed to each other.

Explanations are omitted regarding the elements having the same reference shown in FIG. 1 such as the light receiving portion 3 or the like because they are the same as the fist embodiment.

The operation of the above-mentioned light scattering type particle detector according to the fifth embodiment will be explained hereinafter.

The light La having a wavelength of λ emitted from the LED 11 is condensed with the condensing lens system 12 and introduced to the nonlinear optical crystal 53. The light La having a wavelength of λ is converted into the light Lb having a wavelength of λ/2 when emitted from the nonlinear optical crystal 53.

The light Lb having a wavelength of λ/2 emitted from the nonlinear optical crystal 53 is transmitted through the flow cell 52, reflected on the reflecting mirror 54, transmitted through the flow cell 52 again, reflected back to the nonlinear optical crystal 53, and reflected on the reflecting film 53d of the nonlinear optical crystal 53. In this way, the light Lb having a wavelength of λ/2 is allowed to reciprocate between the reflecting film 53d and the reflecting mirror 54.

Consequently, the light Lb is confined within an area between the reflecting film 53d and the reflecting mirror 54, and thereby higher energy intensity can be obtained compared to the light La emitted from the LED 11.

In addition, since the wavelength of the light Lb which forms the particle detecting area 8 is half of the wavelength of the light La emitted from the LED 11, the intensity of the scattered light from the light Lb is higher than that from the light La. This is because the intensity of light scattered by particles is inversely proportional to the fourth power of the wavelength λ/2 of the light Lb incident upon the particles.

In the above-mentioned embodiments, the LED 11 is used as a light source. However, a lamp or a semiconductor laser can also be used.

As mentioned above, the nonlinear optical crystal 13, 23, 33, 43 or 53 can also emit a fundamental harmonic (light La having a wavelength of λ), a third harmonic (light having a wavelength of λ/3), a fourth harmonic (light having a wavelength of λ/4) and so on as well as a second harmonic (light Lb having a wavelength of λ/2). Although only the case of using a second harmonic is explained in the above-mentioned embodiments, it is expected that the same effect can be obtained in the case of using a third harmonic (having a wavelength of λ/3), a fourth harmonic (having a wavelength of λ/4), or a higher harmonic. However, it becomes necessary to take conversion efficiency into account.

In the above-mentioned embodiments, since the LED 11 is used as a light source, a laser medium such as a solid-state laser is not needed. Therefore, it is not necessary to perform adjustment operation such as structure alignment.

Even if a semiconductor laser is used as a light source, a laser medium such as a solid-state laser is not needed. Therefore, it is not necessary to control the temperature of the semiconductor laser for controlling the wavelength of the laser light emitted from the semiconductor laser to be most suitable to the laser medium. Consequently, it is possible to simplify the driving circuit of the semiconductor laser, make the particle detector small and achieve driving with a battery.

In addition, since particles are irradiated with light having a shorter wavelength than the light from a light source, the intensity of the scattered light is higher than the case where particles are irradiated with the light from a light source directly. This is because the intensity of light scattered by particles is inversely proportional to the fourth power of the wavelength of the light incident upon the particles.

### INDUSTRIAL APPLICABILITY

As mentioned above, according to an aspect of the present invention, since particles are irradiated with light having a shorter wavelength than the light from a light source, it is possible to make the intensity of the scattered light higher than the case where particles are irradiated with the light from a light source directly.

According to another aspect of the present invention, since the light is confined within an area between the reflecting f of the nonlinear optical crystal and the mirror, or between the mirrors, it is possible to obtain higher energy intensity compared to the light emitted from the light source.

1. A light scattering type particle detector in which particles contained in fluid are irradiated with light, and light scattered by the particles is received so as to detect the particles, wherein the light is obtained by converting the wavelength of light emitted from a light-emitting diode or a semiconductor laser with a nonlinear optical crystal.

2. The light scattering type particle detector according to claim 1, wherein the light is reciprocated between a reflecting film of the nonlinear optical crystal and a mirror, or between a mirror and a mirror, which oppose one another with the particle detecting area interposed therebetween.

3. The light scattering type particle detector according to claim 1, wherein the light is emitted from a light-emitting diode.

4. The light scattering type particle detector according to claim 1, wherein the wavelength of the light is converted to a smaller wavelength with the nonlinear optical crystal.

5. The light scattering type particle detector according to claim 1, wherein the wavelength of the light emitted from a light-emitting diode or a semiconductor laser is converted to a harmonic thereof with the nonlinear optical crystal.

6. The light scattering type particle detector according to claim 1, wherein the wavelength of the light emitted from a light-emitting diode or a semiconductor laser is converted to a second harmonic thereof with the nonlinear optical crystal.

7. The light scattering type particle detector according to claim 2, wherein the light is reciprocated between the reflecting film of the nonlinear optical crystal and the mirror, and one of one of the reflecting film of the nonlinear optical crystal and the mirror selectively reflects only the converted wavelength of the light.

8. The light scattering type particle detector according to claim 1, includes a condensing lens system which condenses the light emitted from the light-emitting diode or the semiconductor laser before the light is introduced into the nonlinear optical crystal.

9. A light scattering type particle detector comprising:
a light source including one of a light-emitting diode or a semiconductor laser;
a condensing lens system which condenses the light emitted from the light source;
a nonlinear optical crystal which receives the condensed light and converts a wavelength thereof;
a flowpath through which a fluid containing particles flows, an area of the flowpath being irradiated with the converted wavelength light;
a light sensor which detects light scattered by the particles;
a first reflector which selectively reflects only the converted wavelength light; and
a second reflector which reflects all light; wherein
the first and second reflectors and the flowpath are arranged such that the converted wavelength light is as reciprocally reflected between the reflectors and passes through the area of the flowpath.

10. The light scattering type particle detector according to claim 9, wherein the first and second reflectors are a reflecting film of the nonlinear optical crystal and a mirror, respectively.

11. The light scattering type particle detector according to claim 9, wherein the first and second reflectors are a dichroic mirror and another mirror, respectively.

12. The light scattering type particle detector according to claim 9, wherein the light source includes a light-emitting diode.

13. The light scattering type particle detector according to claim 9, wherein the wavelength of the light is converted to a smaller wavelength with the nonlinear optical crystal.

14. The light scattering type particle detector according to claim 9, wherein the wavelength of the light emitted from a light-emitting diode or a semiconductor laser is converted to a harmonic thereof with the nonlinear optical crystal.

15. The light scattering type particle detector according to claim 9, wherein the wavelength of the light emitted from a light-emitting diode or a semiconductor laser is converted to a second harmonic thereof with the nonlinear optical crystal.

16. The light scattering type particle detector according to claim 10, wherein one of the reflecting film of the nonlinear optical crystal and the mirror selectively reflects only the converted wavelength of the light.
